(19) United States
(12) Patent Application Publication
(10) Pub. No.: US 2004/0064444 A1
(43) Pub. Date: Apr. 1, 2004

(54) Searching words of different sizes

(76) Inventors: Yves Emanuel Villaret, Shikun Peer (IL); Shmuel Prokopets, Bnei Brak (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/333,079

(22) PCT Filed: May 17, 2001
(86) PCT No.: PCT/IL01/00436

(51) Int. Cl. G06F 7/00

(52) U.S. Cl. 707/3

(57) ABSTRACT

A CAM memory for searching Words of variable size, that may be divided into Comparison Units of different sizes, each containing a string of Subwords. The positions of the Subwords at both ends of a Comparison Unit are selected by means of Command Signals. Consequently, words of the data to be searched of any size may be stored contiguously in the Words of the Memory such that all of the Memory may be used for storage and searching. The number of Searching cycles and the time required for finding the position of a word of data is significantly reduced. The Match Signal from a Subword is put out as a Word Match only where the whole string of preceding Subwords of the same Comparison Unit have set Match Signals and the subsequent Command Signal has been set.

### BACKGROUND OF THE INVENTION

It is known to conduct a search operation in an Associative Memory system, wherein a given Word of Data (Search Key) is presented to the memory, and the Associative Memory System returns the position of one Word of Memory storing data identical to that of the Searched Key. This function is implemented in the prior art by associating a comparator with each Word of Memory, such that if the comparator detects identity between data stored in the Word of Memory and the Search Key, a Word Match signal is issued. Where several Words of Memory have matching data, a priority circuit may be used to select a single Match Signal according to predefined criteria and the Address of the Word of Memory issuing this higher priority Match Signal is output.

In existent systems, like Content Addressable Memories (CAMs), the Searched Key must be of a given predefined size, this size being defined by the maximum size of the word searched. These memories are then organized so that the elementary Word of Memory of the CAM is a Word having that maximum size, the reason being that each comparator is designed to compare a pair of words both having the same predefined size.

In case that the Search Key is a word shorter than this maximum size, one commonly used technique consists of:

a) Adding a number of arbitrary bits to the Search Key so that it fits the predefined size.

b) Providing an additional logic circuit that disables the comparison between these arbitrary bits, so that only comparison of the relevant bits is enabled.

The drawback of such systems is that only words that are contained in their entirety within one elementary Word of Memory can be searched. Thus for example, where the maximum size of the word to be searched is eight characters, each character being represented by one byte, the memory will be divided into elementary units each consisting of eight bytes for the comparison process. The eight bytes data presented to the memory will be simultaneously and respectively compared with bytes 1 to 8, as well as with bytes 9 to 16, with bytes 17 to 24 etc. This division of the memory will be further referred to as the Comparison Partition, and the portions of memory defined by that partition as Comparison Units. Obviously, the size of the Comparison Unit equals the Maximum size of the word that can be searched, according to the given specifications of the CAM. In such a memory, in order to enable it to perform a search operation, all words must be stored in the CAM according to an arrangement where each word is separately stored in a respective Comparison Unit. Obviously, this arrangement results in non-efficient use of the memory, since many words may have a size that is shorter than the Comparison Unit. This drawback reduces the efficiency and flexibility of use of such Associative Memories, thus limiting their scope of application. Thus for example, a CAM of this type cannot be efficiently used for searching text files, the reason being that in text files the data is stored in the form of a long string, whereas when the file data are stored in the CAM the position of the words cannot be determined in advance.

Some existent systems provide improvements that allow a limited number of combinations with a number of predefined sizes. One of these systems is a CAM wherein the CAM words can be grouped by logically combining the functions of several CAM words. In that way, it is possible to select the size of the Comparison Unit amongst a small number of predefined sizes. However the variety of Comparison Unit sizes is limited, and for efficient use the stored words still need to be of a size that fits in a Comparison Unit, one word being stored in one comparison unit.

In U.S. Pat. No. 6,000,008 a memory system is described in while successive searching cycles are used to find word strings of different sizes. This system has the disadvantage that the string to be searched must be divided in elementary words, each of them having the size of the search key. It is another drawback of this system that only one elementary word may be searched at a time such that the number of searching cycles needed to find the whole string is equal to the number of elementary words in that string. Another disadvantage of the system of U.S. Pat. No. 6,000,08 is that an additional “begin bit” of memory must be added to each elementary word, thus requiring more circuit area, while the need to set the said “begin bit” to appropriate value before each search operation makes the search operation more complex.

It is therefore desirable to provide means for finding a string of words stored at random position in a memory that enables the full string to be loaded on the search key and compared. It is further desirable to provide a means for significantly reducing the number of searching cycles needed for finding a string of words without superadding further bits of memory.

### SUMMARY OF THE INVENTION

The present invention relates to an Associative Memory system and method for searching words of different sizes that overcomes the drawbacks of the prior art devices by allowing an unlimited number of different sizes for the Comparison Units such that a full string of words may be loaded on the search key and compared. In the scope of this invention, a Comparison Unit is defined by a group of contiguous Words of Memory. These Words of Memory are of a small size that is the minimum required for the application and they will be referred to herein as Sub Words, while the term “Word of Memory” will refer to a string of Sub-Words. The position of the Sub-Words of Memory at both ends of each Comparison Unit can be selected de novo by means of Command Signals before each search operation. Consequently, Words of the data to be searched may be stored contiguously in the Memory whatever the size of those words. Due to this advantage of the inventive system and method, the number of Memory Cells that may be used for storage and searching is considerably increased to include most of the Memory Space. It is a further advantage of the invention that the number of Searching Cycles required for finding the position of a given word of data is significantly reduced, resulting in a reduced searching time.

In a preferred embodiment the Comparison of a String of words may be accomplished in a single cycle.

Such a Memory system and method can be advantageously used for searching data words of different sizes, stored at random positions within the memory. In accordance with yet another advantage, as will be shown, the time needed to search a given word in a text can be significantly reduced. Communication systems, where fast search and filtering operations must be carried out at high speed are one of the many fields of application envisaged for the invention.

### BRIEF DESCRIPTION OF THE DRAWINGS

FIG. 1 shows a Content Addressable Memory (CAM) of the common type, and an example of a text comprising a word ABCD loaded in that CAM.

FIG. 2 shows the number of Patterns to be loaded in the Search Key register and then searched in the CAM in order to find the word ABCD in the data loaded in the CAM.

FIG. 3 shows the arrangement of the inventive Memory system.

FIG. 4 shows details of one Word of Memory and associated circuitry in the inventive Memory system

FIG. 5 shows the reduced number of patterns to be loaded in the Search Key in order to find the word ABCD in case the same data as in FIG. 1 is stored in the inventive Memory system

### DETAILED DESCRIPTION OF THE INVENTION IN RESPECT OF A PREFERRED EMBODIMENT

The present invention concerns a method and system for searching data words of different sizes at random positions in a Content Addressable Memory.

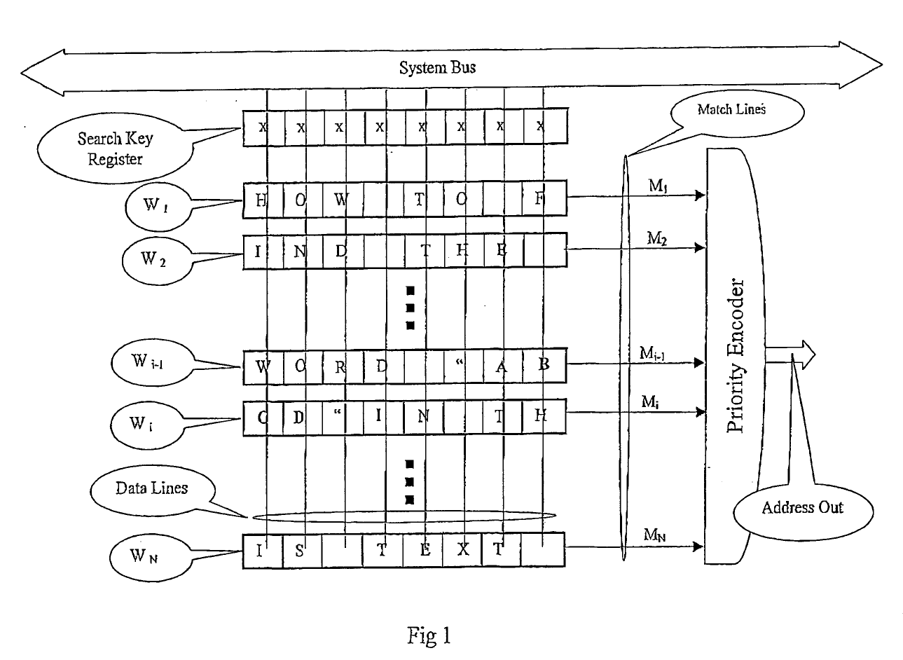

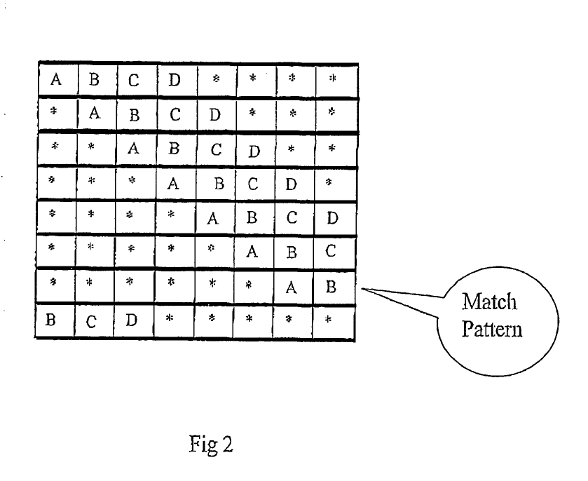

In order to better clarify the advantages of the invention that enable efficient and fast searching for a word of data in an associative memory system and to demonstrate the problems presented by this type of operation and solved by the inventive system and method, a prior art system will now be described in detail, with reference to FIGS. 1 and 2.

Referring to FIGS. 1 and 2, it will be shown how a CAM of common type may be used to search a word in a given text. In particular it will be shown that a large number of searching cycles is needed until the position of the searched word is found.

In FIG. 1, a Content Addressable Memory (CAM) of the common type is shown. The CAM comprises a number of Words of Memory, W₁ to Wₙ, and a Search Key register that stores the word to be searched. Data is loaded to the Search Key register by means of a System Bus. Each Word of Memory is connected to the Search Key register by means of Data Lines, and comprises a comparator that compares the Word stored in the Word of Memory Wᵢ with the Word stored in the Search Key register. When a search operation is executed, this comparator issues a Word Match signal Mᵢ if the word stored in the Word of Memory Wᵢ and the word stored in the Search Key register are equals, or verify a predefined relationship. As several Words of Memory may store Matching Data, several Word Match signals may be issued simultaneously. All these Word Match signals are then input to a priority encoder. The priority encoder selects one match signal, according to a predefined priority, and outputs the address of the corresponding Word of Memory.

Commonly, there are also provided means to mask some bits of the Search Key register in order to disable the comparison on bits that are not relevant for the search operation. If a bit of the Search Key register is masked, all the comparators of the Word of Memory will discard differences between this bit and a bit of the word stored in the Word of Memory, that is at the same position within the Word of Memory as the position of said masked bit within the Search Key register. The search will then result in the Word Match Signal being output by all Words of Memory having matching data for all unmasked bits.

In FIG. 1 is shown an example of Data stored in a prior art CAM memory. In this example, the word of data “ABCD” has been split so that “AB” is stored at the two last characters of the Word of Memory Wᵢ₋₁ and “CD” is stored at the two first characters of the Word of Memory Wᵢ.

In order to find the ABCD word, we need to load in the Search Key register data having the same ABCD word at the same bit position as one of the possible positions of the said ABCD word within the Comparison Unit, and mask all other bits in the Search Key Register. The position of the ABCD word within the Comparison Unit is not known, so that all possible positions must be tried, until we find the match. Also, as in the example shown, the word ABCD may be split between two words, so that we must also take into consideration positions in which the ABCD word is split in two parts, at the end of a word and at the beginning of the next word.

In FIG. 2 are shown the eight different patterns we may have to load in the Search Key register in order to provide for all possible arrangements of the word ABCD. After loading one of these patterns, the CAM is operated to search for it. If the pattern is not found, then another pattern is loaded and the procedure is repeated until either a Match is found or all patterns have been tried. The stars (*) characters in the patterns of FIG. 2 represent bits in the Search Key register that have been masked for the comparison.

It is one of the drawbacks of such systems that even in the case where data have been loaded contiguously in the CAM, as in the example of data shown in FIG. 1, the word to be searched may be split into two consecutive words. A search operation must then be conducted using patterns that contain only part of the searched data. In that case, a Match may be obtained when only a part of the word of memory is matching (*****AB in our example). In such case the possibility still remains that it is not a complete Match, i.e. the two next characters occupying the first two positions of the next word may not be the searched ones, CD in our example. Therefore it will be required to check these two next characters and compare them to the remainig part of the searched string (CD). If the characters do not match, it will be necessary to alter the AB word found so that it will not issue a match signal on a following search, then execute another search operation with the same pattern (*****AB). This procedure will be then repeated until a complete match is found. These successive searching operations may result in a great number of searching operations, depending on the type of data stored. It is a further drawback of this method that the searching procedure should be able to remember the changes done in the memory data and restore the original data at the end of the search operation.

The complexity and low efficiency of the prior art may be demonstrated by an example where the data stored is a random of the alphabet characters (26 characters). In such case there would be in average 26*26=676 time more “AB” words than “ABCD” words. It will be understood that, for our example, the maximum number of searching cycles is 676+8=684, and in general the average number of needed searching cycles can be calculated to be around 47, each searching cycle comprising the steps of searching, checking, modifying and finally restoring data.

As shown above, when searching data with a CAM of the common type, the number of searching cycles needed may be very large, in spite of the enhanced and costly hardware employed for implementing the searching feature of the CAM. Another drawback of the common CAM used for that purpose, is that searching time has a large range of values, i.e. the searching operation may necessitate but a few searching cycles in some cases, and a large number of searching cycles in other cases. The number of searching cycles needed cannot be predicted and this may create difficult synchronization problems where the CAM is integrated in a larger system. These drawbacks have prevented CAMs from being widely used in computer systems, and nowadays the field of application of CAMs is largely restricted to communication systems.

The inventive method and system will now be described in detail. It will be understood that the invention is not limited to the embodiments described or to the drawings attached herein and that many other ways of implementing the invention are possible within the scope of the claims.

The purpose of the present invention is to provide an efficient architecture for a CAM, with the purpose of greatly reducing the number of searching cycles when the CAM is used to find words of data at random positions. According to the present invention, content addressable memories (CAMs) can be designed, that allow searching for a word at any random position in a minimum number of searching cycles. The inventive system and method is also applicable in COM memories (Call Out Memories) such as have been described in PCT applications nos. PCT/IL 00/00121; PCT/IL 00327; PCT/IL 01/00088 and PCT/IL 00096. In accordance with a further advantage of the inventive system the variance of the number of searching cycles needed to find the word is also greatly reduced.

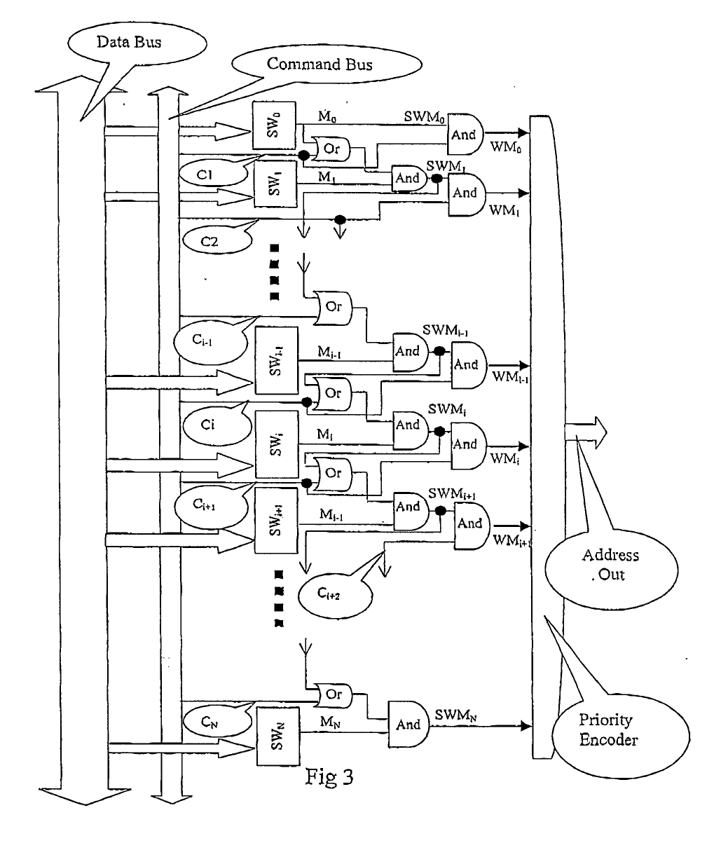

In FIG. 3 the principle of the inventive CAM is shown. As in a common type of CAMS, it comprises words of memory SW₀ to SWₙ. However these words have now been given the minimum size required in the application. If for example, the application is designed for searching Letter Characters, this size would typically be eight bits. In case of application in a communication system, the size may be a single bit. These words will be referred to as Sub-Words, in order to differentiate them from the Words used in CAMs of the prior art.

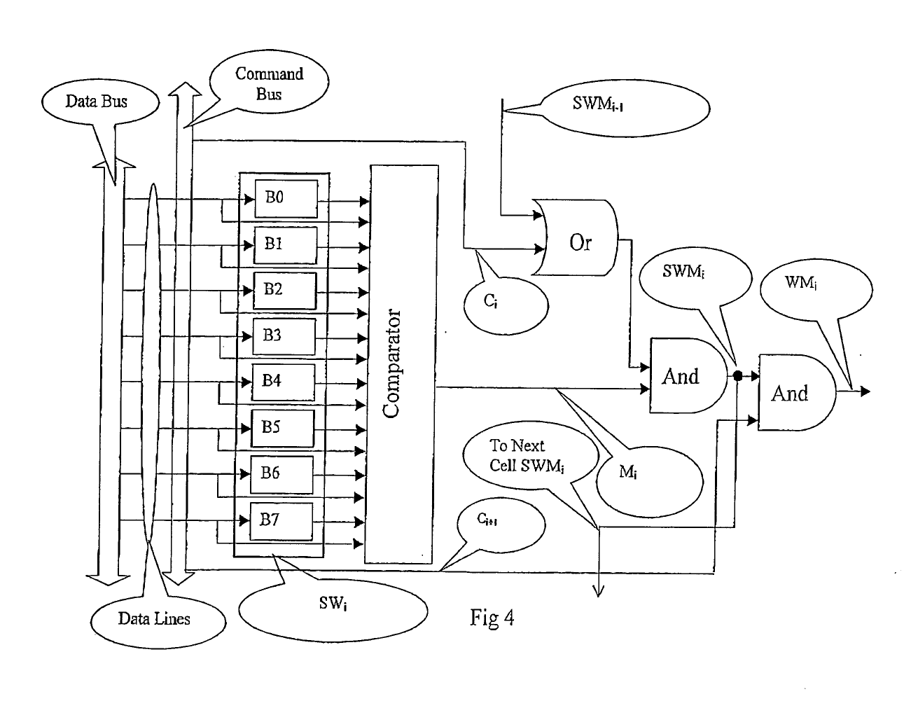

Referring now to FIG. 4, a Sub-Word SWᵢ is shown, comprising eight bits of memory B₀ to B₇, with the associated circuit.

As seen in FIG. 4, each Sub-Word is connected to the Data Bus by means of Data Lines. Data can be stored and/or retrieved in each Sub-Word as known for a common type of memory. As in conventional CAMs, each Sub-Word SWᵢ comprises a comparator. When executing a Search operation, the comparator in each Sub-Word SWᵢ compares the data on the Data Lines with its own Data. If both are equal, or verify a predefined relationship, this comparator outputs a Match signal Mᵢ.

Typically the Data lines will be issued from a Search Key Register used to store the Word to be searched.

In order to implement the inventive variable Comparison Unit, a plurality of Command Signals are defined. These Command Signals may be set by various means, such as by a Command Bus. As seen in FIG. 3 at each Sub-Word (SWᵢ) position, one of the Command Signals (Ci) is associated. This Command Signal is combined with a Sub-Word Match signal (to be defined below) from the previous Sub-Word (SWMᵢ₋₁) in an OR function. The result of this OR function is then combined with the Match output of the Sub-Word (Mᵢ) in an AND function to form a Sub-Word Match output (SWMᵢ). Each Sub-Word Match signal SWMᵢ is then combined in an AND function with the Command Signal Cᵢ₊₁ associated to the next Sub-Word SWᵢ₊₁ to form a Word Match signal WMᵢ. The number of Command Signals is not limited in principle, and it is possible to define a Command Signal for each Sub-Word as in the embodiment of FIG. 3. However in order to reduce the number of Command Signals, a single Command Signal may be defined for several Sub-Words.

It will now be shown how a Comparison Unit is defined as a group of Sub-Words between two Command Signals at logical level 1.

Let us consider for example a case where s is an integer number and Command Signals Cᵢ and Cᵢ₋ₛ are both at logical level 1, while all Command Signals Cᵢ₋ₛ₊₁ until Cᵢ₋₁ are logical level zero. The result of the logical combination on Match Signal will be that Sub-Word Match output SWMᵢ₋₁ will be set only if Match Signal Mᵢ₋₁ is set and all Sub-Words matches SWMᵢ₋ₛ, SWMᵢ₋ₛ₊₁ until SWMᵢ₋₂ are set. This means that the whole string of data in Sub-Words SWᵢ₋ₛ to SWᵢ₋₁ is matching the correspondent string of data set on the Data Bus lines connected to these Sub-Words. In that case, all Sub-Word signals SWMᵢ₋ₛ, SWMᵢ₋ₛ₊₁ until SWMᵢ₋₁ are set, but Word Match signals WMᵢ₋ₛ, WMᵢ₋ₛ₊₁ until WMᵢ₋₂ are not set since the Command Signals Cᵢ₋ₛ₊₁, Cᵢ₋ₛ₊₂ until Cᵢ₋₁ are all at logical level 0. Only Word Match signal WMᵢ₋₁ is set since Command Signal Cᵢ is also set. This WMᵢ₋₁ signal thus contains the result of a comparison between the whole string of data stored in Sub-Words SWMᵢ₋ₛ, SWMᵢ₋ₛ₊₁ until SWMᵢ₋₁ and the correspondent data set on the Data bus.

As a result, the set Command Signals now define Comparison Units delimitations, i.e. each set Command Signal Cᵢ defines the Sub-Word SWᵢ₋₁ as the last Sub-Word of a Comparison Unit and the Sub-Word SWᵢ as the Starting Sub-Word of the next Comparison Unit. By selectively setting the Command Signals, it is now possible to define Comparison Units of any size and at any position.

As in conventional CAMs and in the innovative COMs described in PCT applications nos. PCT/IL 00/00121; PCT/IL 00327; PCT/IL 01/00088 and PCT/IL 00096, all Word Match outputs are then input to the priority encoder and according to the specific priority defined, the priority encoder will output the address of one of the Sub-words having a Word Match signal set.

The following is an example of how a search operation can be done, using the inventive CAM and a small number of searching cycles.

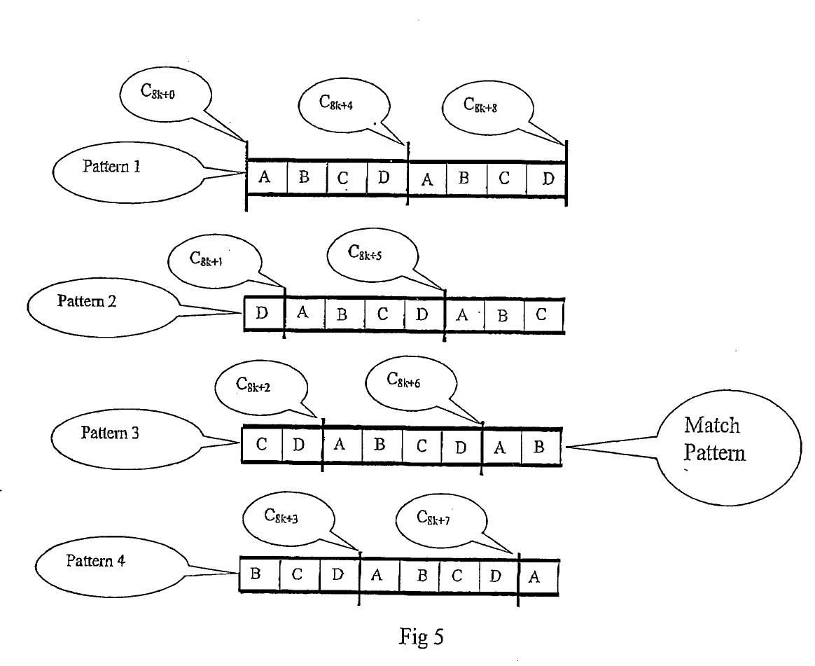

FIG. 5 shows the set of patterns used to search the word “ABCD” of the previous example of FIG. 1. The Search Key size is eight Sub-Words, each Sub-Word storing one character. The word to be searched is composed of four Sub-Words. When loading the Search Word in the Search Key register, there are eight possibilities for choosing the position for the first Sub-Word, i.e. we can load the “ABCD” string starting with any of the Sub-Words of the Search Key register. However, having in mind that we can define the starting position and the size of the Comparison Units, we can now load the same Searched Key twice in the Search Key register since the Search Key register size is twice that of the searched word. Also, we can write the Searched String “looping around” the size of the Search Key register, i.e. when loading the Searched String, if the end of the Searched Key register is reached, we continue loading from the first Sub-Word of the Search-Key register. Each time a pattern is loaded in Search Key register, the Command Signals are set in order to adapt the size of the Comparison Units to the searched pattern.

In our example we need to apply only four different patterns of the Search Key register in order to search the “ABCD” word.

In FIG. 5, these four search patterns are shown. Also shown, as bold lines, are the Command Signals set to logical level—one Command Signal for each of the searches conducted under these patterns. In this particular example, Command Signals are set in a cyclic order, the cycle period being 8 Sub-Words. The number k represents an integer and the designation 8k+0 for example represents a cyclic setting of the Command Signals wherein lines 0, 8, 16 . . . etc. are all set.

Referring again to FIG. 5, it will be noted that pattern 3 results in a Match. This match is on the entire searched word, since in that search the command lines 8k+2 and 8k+6 are set, defining a comparison unit comprising the entire word ABCD so that there is no need for additional reading or searching cycles, and the maximum number of cycles needed to find the ABCD word will be 4 while the average number will be 2.5 cycles.

It will be understood that this inventive CAM greatly reduces the number of searching cycles required for finding a word of memory.

As a result, the inventive CAM provides the following advantages over the prior art methods and systems:

a) A much faster searching operation is enabled

b) The words of data to be searched need not be arranged in the memory according to a predefined order so as to enable search operations.

It is a further advantage of the inventive system and method that the memory space required to store the data is considerably reduced, and loading time is also reduced since the data can be loaded in the memory in its natural order.

It will be understood that the setting of the Signal Lines may be performed in many different ways, according to the needs of the specific application.

Thus for example, in a preferred embodiment, a Command Bus may comprise a number of lines, that number being a multiple of the number of Sub-Words of the Search Key register. In this embodiment, the Command Signals may have a cyclic connection to the Command Bus, the cycle length being the number of Command Bus Lines. Thus for example, where the Search Key contains eight Sub-Words, and the Command Bus comprises sixteen lines, Command Signals C0, C16, C32 . . . will be connected to Command Bus line 0, Command Lines C1, C17, C33 . . . will be connected to Command Bus line 1 etc . . .

In another preferred embodiment, the Search Key register may comprise a number of Sub-Words that is a multiple of the number of Lines of the Command Bus. In this second embodiment, the Command Signals may have a cyclic connection to the Command Bus, the cycle length being the number of Command Bus Lines. For example, where the Search Key contains eight Sub-Words, and the Command Bus comprises four lines, Command Signals C0, C4, C8 . . . will be connected to Command Bus line 0, Command Signals C1, C5, c9 . . . will be connected to Command Bus line 1 etc . . .

In yet another preferred embodiment, the Command Signals may be set by a logical combination of the values stored in the Sub-Word. One application envisaged for this preferred embodiment, is searching words inside a text. In a text words are usually separated by spaces, dots and other characters, hereinbelow designated “separators”. A logic circuit is then associated to each Subword, the output of that logic circuit being a set signal if the subword is storing a separator. This signal is then used as the Command Signal for that Sub-Word. In that way, the Comparison Unit size is fit to the Word size, so that each Word of the text stored in the CAM defines one Comparison Unit.

In all of the above described embodiments Searching a Word will be done by placing the searched word on the Search Key several times, each time shifting the position of the first character of the word in the Search Key, until a Match is found. As explained before, when placing the word in the Search key and shifting the position of the first character, in case there is not enough room to load the entire word, the remaining part of the word is loaded in a Looping Around fashion, i.e. restarting at the first Sub-Word of the Search Key.

According to one of the advantages of the present invention, it is applicable for any size of the Sub-Word, and this size may vary inside the CAM array.

The present invention is also applicable where not all the Sub-Words are associated with a Command Signal. In that case, depending on the specification of the CAM, the Word Match Signal at a non-connected Sub-Word is issued depending on the state of a specific logic circuit at that position. For example in case no Command Signal is associated at Sub-Word SWi, the logic circuit may be designed so as to give the same function as if a command line with a fixed state were associated, thus providing fixed partition definition at a number of fixed positions. The Logic function used may be of any known kind.

The method and circuit of the present invention are not dependent on the type of the priority circuit used in CAMs and COMs, and may therefore be used with CAMs or COMs, adding more functionality to these devices, and extending their fields of application.

It will be understood that the principle of the invention has been described here in respect of an increasing order of the Memory Sub-Words. Obviously the same principle may be applied using a decreasing order of the Memory Sub-Words. Furthermore, the order of the Sub-Words may be defined arbitrarily. In particular, it is not necessarily the same as that defined by the usual Address of the memory Sub-Words. It will be further understood that while the preferred embodiment has been described as a method and system wherein the Searched Data is loaded in a Search-Key register other designs are envisaged for the invention. Thus for example the data to be searched may be directly connected to the Sub-Words by means of Data Lines.

In accordance with another aspect of the inventive Memory System, it may also be applied for detecting, in an input stream of word strings, the presence of one or several words among a given list of such words. In this application, the list of words is prestored in the memory and the command signals are set so as to define comparison units that coincide with these stored words. The input stream is then loaded by packets of a size equal to that of the search key and each packet is compared with the prestored words in the CAM. If a match occurs, it means that at least one of the prestored words is present in the input stream.

1) A Content Addressable Memory for searching words of different sizes at random positions that is divided into elementary memory units (Sub-Words) arranged in a predefined order, wherein each Sub-Word comprises a comparator, each Sub-Word is connected to one or more Data Lines and each Sub-Word is designed to output a Match signal in case the data stored in the said Sub-Word and the data on the said data lines verify a predefined relationship; the said Content Addressable Memory comprising means for selectively partitioning said Content Addressable Memory into Comparison Units each Comparison Unit comprising a selectable number of contiguous Sub-Words and for selecting the position of the Lowest Sub-Word and the Highest Sub Word of the said Comparison Unit in the said predefined order, wherein each Comparison Unit is designed to output a Word Match signal if all Sub-Words of the said Comparison Unit output a Sub-Word match signal.

2) A Content addressable memory as claimed in claim 1 hereinabove wherein each of the said comparison units is designed to output the said Word Match signal in a single cycle.

3) A Content Addressable Memory according as claimed in either of claims 1 or 2 hereinabove wherein the said Content Addressable Memory is also provided with means that enable it to operate in a Call Out mode.

4) A Content Addressable Memory according to any of claims 1-3 hereinabove wherein the said Sub Words have the minimum size required in the application.

5) A Content Addressable Memory as claimed in any of claims 1-4 hereinabove wherein the said Content Addressable Memory is also provided with means that enable the Data Lines to be masked for the comparison.

6) A Content Addressable Memory according to any of claims 1-5 hereinabove wherein the said means for selectively partitioning said Memory and for defining the said Lowest and Highest Subwords of the said Comparison Units are a set of Command Signals, each Command Signal being associated to at least one Sub-Word.

7) A Content Addressable Memory according to any of claims 1-6 hereinabove wherein the said means for selectively partitioning said Content Addressable Memory and for defining the said Lowest and Highest Subwords of the said Comparison Units are a set of Command Lines, each Command Line being associated to at least one Sub-Word.

8) A Content Addressable Memory according to claim 7 hereinabove wherein the said Command Signals are cyclically connected to a set of Command lines such that if the said set of Command Lines contains n lines, the Command Signal of a Sub Word with index j is connected to the line r where r is the rest of the division of n by j.

9) A Content Addressable Memory according to claim 7 hereinabove wherein the said set of Command Lines is comprised in a Command Bus.

10) A Content Addressable Memory according to any of the preceding claims wherein some Sub Words are not associated with any Command Signal and the Word Match Signal at the each of the said non-connected Sub Words respectively is issued according to a specific logic circuit at that position.

11) A Content Addressable Memory according to claim 10 hereinabove wherein the said logic circuit gives the same function as if a Command Line with a fixed state were associated to the said Sub Word whereby fixed partition definition may be provided at a number of fixed positions within the said Content Addressable Memory.

12) A Content Addressable Memory according to any of the preceding claims wherein the size of the said Comparison Units is equal and fixed, the said Content Addressable Memory comprising means for changing the positions of the first and last Subwords within the said Comparison Units.

13) A Method for searching Words of different sizes at random positions in a Content Addressable Memory comprising the following steps;
a) Setting the data of the Word to be searched on the Data lines of the said Content Addressable Memory
b) partitioning the said Content Addressable Memory into Comparison Units by defining a Lowest Subword in a predefined order for a Comparison Unit and the Highest Subword in the said predefined order for a preceding Comparison Unit such that each of the said Comparison Units contains a string of Subwords that equals the size of the said Word of Data to be searched
c) performing a logical function of outputting a Sub-Word Match Signal for a Sub-Word SWi within the said string of Sub words in case that i)_ The Match signal of the said Sub Word SWi is output, ii)_ Either the Sub-Word Match signal of a Sub-Word that is preceding to the said Sub word SWi according to a predefined order is output or a Command Signal associated to the said Sub-Word SWi is set by means of a logic circuit associated to the said Sub Word SWi.
d) Performing a logical function of outputting a Word Match signal in case that both the Sub-Word match signal of said Sub-Word SWi and a Command Signal associated to a subsequent (in a predefined order) Sub-Word are output by means of a second logic circuit associated to the said Sub-Word.

14) A Method for searching Words of different sizes in a Content Addressable Memory according to claim 13 hereinabove wherein the said logical function of outputting a Word Match signal is performed in a single cycle.

15) A Method for searching Words of different sizes in a Content Addressable Memory according to either of claims 13 or 14 hereinabove wherein the said Content Addressable Memory is also provided with means that enable it to operate in a Call Out mode.

16) A method for searching Words of different sizes in a Content Addressable Memory according to any of claims 13-15 hereinabove wherein the said Comparison Units are defined by a set of Command Signals, each Command Signal being associated to at least one Sub Word and wherein the Lowest Sub Word in a predefined order within the Subword string of a Comparison Unit is the Sub Word to which the said Command Signal is associated and wherein the Highest Subword in the said predefined order within the respective Sub Word string of a preceding Comparison Unit is a Sub word preceding the said Sub Word to which the Said Command Signal is associated.

17) A Method for searching Words of different sizes in a Content Addressable Memory according to any of claims 14-16 hereinabove wherein some or all of the said Command Signals are set by means of a plurality of Command Lines.

18) A Method for searching Words of different sizes in a Content Addressable Memory according to any of claims 14-17 hereinabove wherein some or all of the said Command Signals respectively associated to the said Sub Words are the result of the logical combination of Data stored in their respective Sub Words and/or in other subwords.

19) A Method for searching Words of different sizes in a Content Addressable Memory according to claim 18 hereinabove wherein a Command Signal is set when the Data stored in the Sub Word associated with the said Command Signal is a separator such as a space, dot or similar character.

20) A Method for searching Words of different sizes in a Content Addressable Memory according to any of claims 13-19 hereinabove wherein at one or more positions the said Word Match Signal is set according to a specific logic circuit.

21) A Method for searching Words of different sizes in a Content Addressable Memory according to any of claims 13-20 hereinabove wherein the said Command Signals have a constant state.

22) A method for searching Words of different sizes in a Content Addressable Memory according to any of claims 13-21 hereinabove wherein some data bits on the Data Lines are masked for the comparison.

23) A method for searching Words of different sizes in a Content Addressable Memory according to any of claims 13-22 hereinabove wherein the said method also comprises inputting all Word Match Outputs in a priority encoder that will output the address of one String of Subwords among all the Strings of Sub words having a Word Match Signal set, according to a predefined priority.

24) A method for detecting, in an input stream of word strings, the presence of one or several words among a given list of such words, using a Content Accessible Memory as claimed in any of claims 1-12.

25) A Method for searching Words of different sizes in a Content Addressable Memory substantially as described herein with reference to the drawings.

26) A Content Addressable Memory for searching words of different sizes substantially as described herein with reference to the drawings.
